(19) United States
(12) Patent Application Publication
(10) Pub. No.: US 2020/0067715 A1
(43) Pub. Date: Feb. 27, 2020

(54) SECURITY VERIFICATION METHOD FOR VEHICLE-MOUNTED DEVICE, ELECTRONIC APPARATUS, AND READABLE STORAGE MEDIUM

(71) Applicant: BOE TECHNOLOGY GROUP CO., LTD., Beijing (CN)

(72) Inventors: Zhusong YI, Beijing (CN); Yue YU, Beijing (CN)

(21) Appl. No.: 16/439,345

(22) Filed: Jun. 12, 2019

(30) Foreign Application Priority Data
Aug. 22, 2018 (CN) 201810962619.9

(51) Int. Cl. H04L 9/32; G06F 21/57

(52) U.S. Cl. CPC H04L 9/3247; H04L 9/3265; H04L 2209/80; H04L 2209/84; G06F 21/575

(57) ABSTRACT

The present disclosure relates to a vehicle-mounted device and a security verification method for the vehicle-mounted device. The security verification method for the vehicle-mounted device includes: acquiring a target object to be verified in at least one security verification location, the security verification location being a node location to be security-verified after the vehicle-mounted device is powered up; and performing a security verification on the target object. The target object is allowed for use when the security verification succeeds, but the target object is prohibited from being used when the security verification fails.

### CROSS-REFERENCE TO RELATED APPLICATION

This application is based upon, and claims the benefit of and priority to, Chinese Patent Application No. 201810962619.9, filed on Aug. 22, 2018, the entire contents thereof are incorporated herein by reference.

### TECHNICAL FIELD

The present disclosure generally relates to the field of display technologies and, more particularly, to a vehicle-mounted device and a method of security verification for the vehicle-mounted device.

### BACKGROUND

With the development of automobiles from mechanization to intelligence, more and more software systems are mounted in vehicle-mounted devices. However, security is a non-negligible issue. Security strategies used by traditional vehicle-mounted software systems usually include security strategies focused in the data transmission level to ensure that vehicle information is not intercepted and vehicle control information is not randomly written. However, with the development of the automobiles and systems thereof being more intelligent, serious security problems may be caused if the vehicle-mounted devices only use security strategies in the data transmission level. Therefore, information security of vehicle-mounted devices needs to be further improved.

### SUMMARY

According to a first aspect of embodiments of the present disclosure, there is provided a method of security verification for a vehicle-mounted device, which includes:

acquiring a target object to be verified in at least one security verification location, the security verification location being a node location to be security-verified after the vehicle-mounted device is powered up; and

performing a security verification on the target object, the target object being allowed for use when the security verification succeeds, and the target object being prohibited from being used when the security verification fails.

In one embodiment, key pairs used in the security verification in different security verification locations are different.

In one embodiment, the security verification location may be a node location where a system boot program is executed, and the target object may be the system boot program carrying a signature.

Before the target object to be security-verified in at least one security verification location is acquired, the security verification method may further include: executing a power-up boot program by the vehicle-mounted device after the vehicle-mounted device is powered up.

The performing of the security verification on the target object may include:

acquiring a first public key authorized in the process of executing the power-up boot program; and

performing a signature verification on the system boot program carrying the signature according to the first public key.

In one embodiment, after the signature verification on the system boot program carrying the signature according to the first public key is performed, the security verification method may further include:

launching the system boot program to acquire a second public key authorized when the system boot program carrying the signature succeeds in the signature verification; and

performing a signature verification on a boot parameter carrying a signature according to the second public key.

The system boot program is terminated when the boot parameter carrying the signature fails in the signature verification, and the system boot program sets the boot parameter when the boot parameter carrying the signature succeeds in the signature verification.

In one embodiment, after the system boot program sets the boot parameter, the security verification method may further include:

determining whether to execute a kernel image; and

performing a signature verification on the kernel image carrying a signature and a designated image when it is determined to execute the kernel image.

The kernel image is executed when both the kernel image carrying the signature and the designated image succeed in the signature verification, and the kernel image is prohibited from being executed and the system boot program is terminated when either of the kernel image carrying the signature and the designated boot image fails in the signature verification.

In one embodiment, after the determining whether to execute a kernel image, the security verification method may further include:

performing a signature verification on a recovery image carrying a signature when it is determined not to execute the kernel image, executing the recovery image when the recovery image succeeds in the signature verification, and performing a signature verification on an image carrying a signature in an upgrade package in the process of executing the recovery image, wherein the executing of the recovery image is terminated when any image in the upgrade package fails in the signature verification; and

prohibiting the recovery image from being executed and terminating the system boot program when the recovery image fails in the signature verification.

In one embodiment, the security verification location is a node location where an application program is installed, and the target object is an application program carrying a signature. The performing of the security verification on the target object may include:

acquiring a third public key authorized; and

performing a signature verification on the application program carrying the signature according to the third public key.

The application program is installed when the signature verification succeeds; and the application program is prohibited from being installed when the signature verification fails.

In one embodiment, the security verification location is a node location where a target application program is loaded for a first time, and the target object is an executable file carrying a signature of the target application program. The performing of the security verification on the target object includes:

acquiring a fourth public key authorized; and

performing a signature verification on the executable file carrying the signature according to the fourth public key.

The executable file is extracted and is loaded into a memory when the signature verification succeeds, and the target application program is prohibited from being launched when the signature verification fails.

According to a second aspect of the embodiments of the present disclosure, there is provided a vehicle-mounted device, which includes:

an acquiring module, configured to acquire a target object to be verified in at least one security verification location, the security verification location being a node location to be security-verified after the vehicle-mounted device is powered up; and

a first verification module, configured to perform a security verification on the target object, wherein the target object is allowed for use when the security verification succeeds, and the target object is prohibited from being used when the security verification fails.

In one embodiment, the security verification location may be a node location where a system boot program is executed, and the target object may be the system boot program carrying a signature. The vehicle-mounted device may further include:

an executing module, configured to execute a power-up boot program after the vehicle-mounted device is powered up.

The first verification module includes:

a first acquiring submodule, configured to acquire a first public key authorized in the process of executing the power-up boot program; and

a first verification submodule, configured to perform a signature verification on the system boot program carrying the signature according to the first public key.

In one embodiment, the first verification module may further include:

a launching submodule, configured to launch the system boot program to acquire a second public key authorized when the system boot program carrying the signature succeeds in the signature verification; and

a second verification submodule, configured to perform a signature verification on a boot parameter carrying a signature according to the second public key, wherein the system boot program is terminated when the boot parameter carrying the signature fails in the signature verification, and the system boot program sets the boot parameter when the boot parameter carrying the signature succeeds in the signature verification.

In one embodiment, the security verification location may a node location where an application program is installed, and the target object may be an application program carrying a signature.

The first verification module includes:

a second acquiring submodule, configured to acquire a third public key authorized; and

a third verification submodule, configured to perform a signature verification on the application program carrying the signature according to the third public key, wherein the application program is installed when the signature verification succeeds, and the application program is prohibited from being installed when the signature verification fails.

In one embodiment, the security verification location may be a node location where a target application program is loaded for a first time, and the target object may be an executable file carrying a signature of the target application program.

The first verification module may include:

a third acquiring submodule, configured to acquire a fourth public key authorized; and

a fourth verification submodule, configured to perform a signature verification on the executable file carrying the signature according to the fourth public key, wherein the executable file is extracted and is loaded into a memory when the signature verification succeeds, and the target application program is prohibited from being launched when the signature verification fails.

According to a third aspect of the embodiments of the present disclosure, there is provided an electronic device, which includes a processor and a memory.

The memory is configured to store a computer program.

The processor is configured to execute the computer program stored on the memory to implement the method described above.

According to a fourth aspect of the embodiments of the present disclosure, there is provided a non-transitory computer-readable storage medium, which stores a computer program. When the computer program is executed by the processor, the above method is implemented.

It is to be understood that both the foregoing general description and the following detailed description are exemplary and explanatory only and are not restrictive of the present disclosure.

### BRIEF DESCRIPTION OF THE DRAWINGS

The accompanying drawings herein are incorporated in and constitute a part of this specification, illustrating embodiments conforming to the present disclosure and, together with the description, serve to explain the principles of the present disclosure.

FIG. 1 illustrates a flowchart of a security verification method for a vehicle-mounted device according to an embodiment of the present disclosure;

FIG. 2 illustrates a schematic format diagram of a system boot program carrying a signature according to an embodiment of the present disclosure;

FIG. 3 illustrates a schematic structural diagram of a system launcher according to an embodiment of the present disclosure;

FIGS. 4A-4B illustrate a flowchart of another security verification method for a vehicle-mounted device according to an embodiment of the present disclosure;

FIG. 5 illustrates a flowchart of still another security verification method for a vehicle-mounted device according to an embodiment of the present disclosure;

FIG. 6 illustrates a schematic structural diagram of an App installer according to an embodiment of the present disclosure;

FIG. 7 illustrates a schematic format diagram of an installation package carrying a signature according to an embodiment of the present disclosure;

FIG. 8 illustrates a flowchart of still another security verification method for a vehicle-mounted device according to an embodiment of the present disclosure;

FIG. 9 illustrates a schematic structural diagram of an App runner according to an embodiment of the present disclosure;

FIG. 10 illustrates a schematic format diagram of a Classex.dex carrying a signature according to an embodiment of the present disclosure;

FIG. 11 illustrates a schematic diagram of an Android operating system launching App according to an embodiment of the present disclosure;

FIG. 12 illustrates a schematic structural diagram of a vehicle-mounted device according to an embodiment of the present disclosure;

FIG. 13 illustrates a schematic structural diagram of another vehicle-mounted device according to an embodiment of the present disclosure;

FIG. 14 illustrates a schematic structural diagram of still another vehicle-mounted device according to an embodiment of the present disclosure;

FIG. 15 illustrates a schematic structural diagram of still another vehicle-mounted device according to an embodiment of the present disclosure;

FIG. 16 illustrates a schematic structural diagram of still another vehicle-mounted device according to an embodiment of the present disclosure; and

FIG. 17 illustrates a schematic structural diagram of an electronic device according to an embodiment of the present disclosure.

### DETAILED DESCRIPTION

Reference will now be made in detail to exemplary embodiments, examples of which are illustrated in the accompanying drawings. When accompanying figures are mentioned in the following descriptions, the same numbers in different drawings represent the same or similar elements, unless otherwise represented. The implementations set forth in the following description of exemplary embodiments do not represent all implementations consistent with the invention. Instead, they are merely examples of apparatus and methods consistent with aspects related to the disclosure as recited in the appended claims.

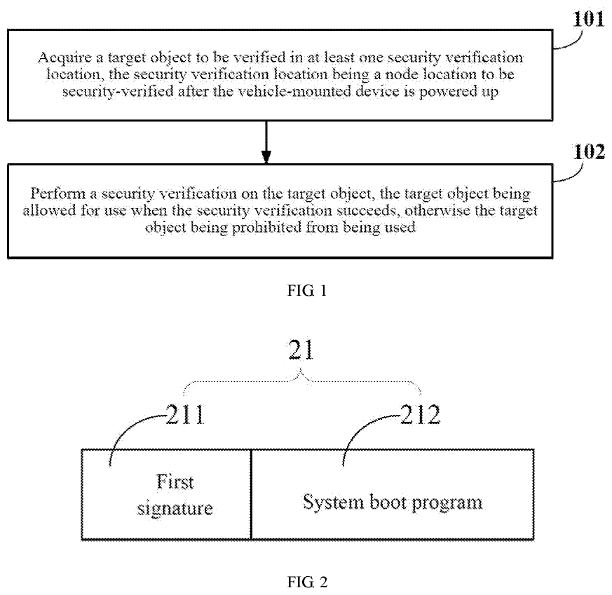

FIG. 1 illustrates a security verification method for a vehicle-mounted device according to an embodiment of the present disclosure. The security verification method for a vehicle-mounted device may be applied to a vehicle-mounted device. The vehicle-mounted device may be, for example, a vehicle central controller, a vehicle-mounted controller, an electronic control unit (ECU), a vehicle control unit (VCU), and so on, and the electronic control unit is also known as a vehicle-mounted computer. As shown in FIG. 1, the security verification method for a vehicle-mounted device includes Steps 101˜102 as follows.

In Step 101, a target object to be verified in at least one security verification location is acquired. The security verification location is a node location to be security-verified after the vehicle-mounted device is powered up (or powered on).

In Step 102, a security verification is performed on the target object. The target object is allowed for use when the security verification succeeds, and the target object is prohibited from being used when the security verification fails.

In one embodiment, there may be a plurality of security verification locations in the vehicle-mounted device. Key pairs used when performing a security verification in different security verification locations may be different. In this regard, information security of the vehicle-mounted device may be greatly enhanced. In one embodiment, the above key pair may be generated using a preset encryption algorithm. The preset encryption algorithm may be, for example, an RSASSA-PKCS1-v1_5 algorithm. The public key and the private key may be separated, and an insecure channel may also be used, providing good versatility. The preset encryption algorithm also may be an ElGamal algorithm, an elliptic curve algorithm, and the like. The ElGamal algorithm has good security. The elliptic curve algorithm has high security, less calculation amount, less storage space, and lower bandwidth requirements. Each key pair includes a private key and a public key. In an exemplary embodiment, the private key may be used for encryption, and the public key may be used for decryption. In an exemplary embodiment, the public key may be used for encryption, and the private key may be used for decryption. In some embodiments of the present disclosure, an example is taken for illustration where the private key is used for encryption and the public key is used for decryption.

In an exemplary embodiment, the security verification location may include: a node location where a system boot program is executed, anode location where a boot parameter is set, a node location where a kernel image is executed, a node location where a recovery image is executed, a node location where an application program is installed, and a node location where a target application program is loaded for a first time. For ease of understanding, the meanings of “nodes” herein are explained below. The “nodes” herein essentially are “process nodes.” When one project requires to be completed by a plurality of different procedures (processes) or in a plurality of stages, a transfer point (a category point or a time point) at the end of a certain procedure or a certain stage and at the beginning of another procedure or another stage is referred to as a “process node.” The target object corresponding to the node location where the system boot program is executed may be a system boot program carrying a signature. The target object corresponding to the node location where the boot parameter is set may be a boot parameter carrying a signature. The target object corresponding to the node location where the kernel image is executed may be a kernel image carrying a signature and a designated image. The target object corresponding to the node location where the recovery image is executed may be a recovery image carrying a signature and an image carrying a signature in an upgrade package. The target object corresponding to the node location where an application program is installed may be an application program carrying a signature. The target object corresponding to the node location where the target application program is loaded for a first time may be an executable file carrying a signature. In this exemplary embodiment, a security verification may be performed using the following four key pairs generated using the above RSASSA-PKCS1-v1_5 algorithm.

Private key 1 encryption—public key rsa key1 decryption

Private key 2 encryption—public key rsa key2 decryption

Private key 3 encryption—public key rsa key3 decryption

Private key 4 encryption—public key rsa key4 decryption

The public key rsa key1 is the first public key, the public key rsa key2 is the second public key, the public key rsa key3 is the third public key, and the public key rsa key4 is the fourth public key.

A security verification performed on the system boot program carrying the signature in the node location where the system boot program is executed may be taken as an example below for illustration. To ensure the system launch security of the vehicle-mounted device, the vehicle-mounted device may acquire the first public key rsa key1 authorized and the system boot program carrying the signature in the node location where the system boot program is executed in the process of executing a power-up boot program after the vehicle-mounted device is powered up, and a signature verification is performed on the system boot program carrying the signature according to the first public key rsa key1. The system boot program may be launched after the system boot program carrying the signature succeeds in the signature verification. Otherwise, launching the system boot program is prohibited.

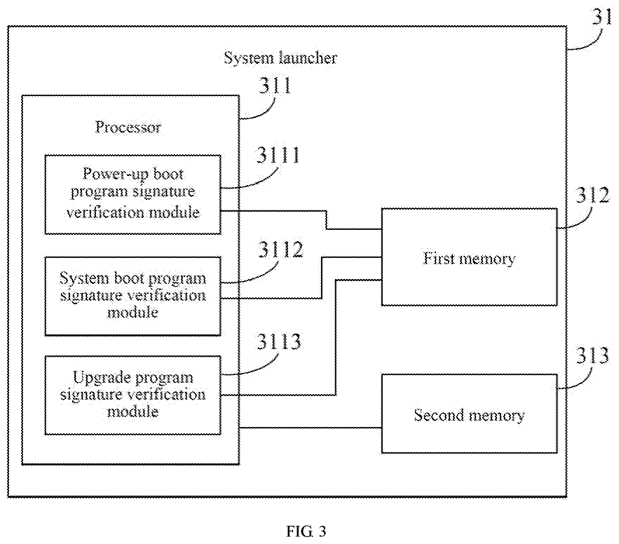

Specifically, as shown in FIG. 2 to FIG. 3, the signature-carrying system boot program 21 includes the following two parts: a first signature 211 and a system boot program 212. Before the signature-carrying system boot program 21 is written into the vehicle-mounted device, a digest may be first calculated using the SHA1 algorithm. Then, the digest is encrypted with the private key 1 by using the RSASSA-PKCS1-v1_5 algorithm to obtain the first signature 211, and, thereafter, the first signature 211 and the system boot program 212 are combined to obtain the signature-carrying system boot program 21. The vehicle-mounted device may store the received signature-carrying system boot program 21 into the second memory 313 of the system launcher 31 as shown in FIG. 3. The second memory 313 may be a non-volatile memory device, such as ROM, FLASH, EMMC, or the like. Calculating the digest using the SHA1 algorithm is high in security, is not easily decrypted, and is better in compatibility. Some relatively mature hardware infrastructures support hardware acceleration of this algorithm. Of course, the digest also may be calculated using various algorithms, such as MD4, MD5, and SHA2. The MD5 algorithm is better in anti-analysis and anti-differential aspects.

The processor 311 can include a hardware processor. The processor 311 executes the power-up boot program after the vehicle-mounted device is powered up. The meaning of “power-up” refers to “energization.” In the process of executing the power-up boot program, in the node location where the system boot program is executed, the power-up boot program signature verification module 3111 may acquire the first public key rsa key1 authorized from the first memory 312, and may acquire the signature-carrying system boot program 21 from the second memory 313. The first memory 312 may be a security memory. Next, the power-up boot program signature verification module 3111 may perform a signature verification on the signature-carrying system boot program 21 according to the first public key rsa key1. Specifically, the power-up boot program signature verification module 3111 may decrypt the first signature 211 using the first public key rsa key1 to obtain a decrypted signature byte, and may calculate the digest of the system boot program 212 using the SHA1 algorithm. Next, the power-up boot program signature verification module 3111 may compare the digest of the system boot program 212 with the decrypted signature byte. If the digest of the system boot program 212 is consistent with the decrypted signature byte, it is determined that the signature-carrying system boot program 21 belongs to a legal image, the security verification succeeds, and the system boot program may be allowed to be launched. If the digest of the system boot program 212 is inconsistent with the decrypted signature byte, it is determined that the signature-carrying system boot program 21 belongs to an illegal image, the security verification fails, and the system boot program may be prohibited from being launched.

Similarly, the processor 311 may perform a security verification on the boot parameter carrying the signature using the second public key rsa key2 in the node location where the boot parameter is set, may perform a security verification on the application program carrying the signature using the third public key rsa key3 in the node location where the application program is installed, and may perform a security verification on the executable file carrying the signature using the fourth public key rsa key4 in the node location where the target application program is loaded for the first time.

In some embodiments of the present disclosure, from the beginning of launching a soft system mounted in the vehicle-mounted device, the vehicle-mounted device performs a security verification on a target object to be verified in each security verification location in the whole life cycle of the soft system. The target object is allowed for use when the security verification succeeds, and the target object is prohibited from being used when the security verification fails. In this regard, information security of the vehicle-mounted device may be improved.

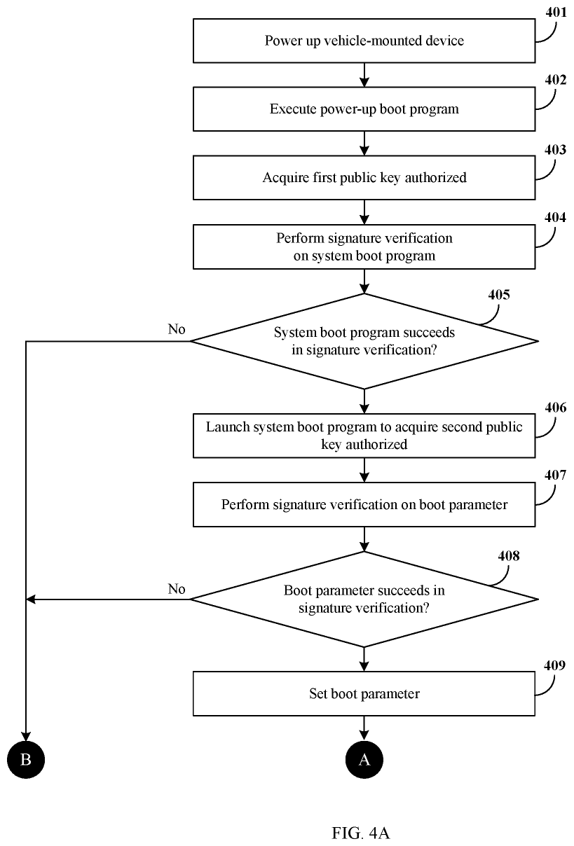

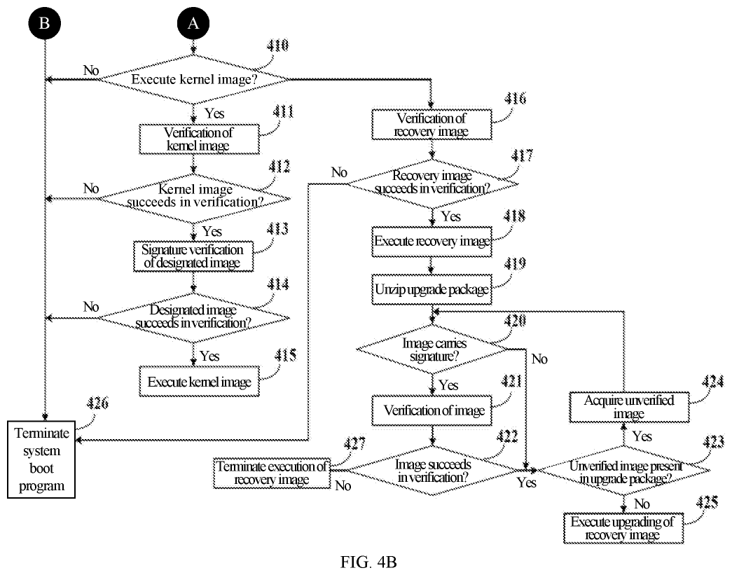

FIGS. 4A-4B illustrate yet another security verification method for a vehicle-mounted device according to an embodiment of the present disclosure, to ensure system launch security of the vehicle-mounted device. As shown in FIGS. 4A-4B, the security verification method for a vehicle-mounted device may include the following Steps 401˜427.

In Step 401, the vehicle-mounted device is powered up.

In Step 402, a power-up boot program is executed.

In Step 403, the first public key authorized is acquired.

In these steps, in the process of executing the power-up boot program by the processor, the power-up boot program signature verification module 3111 may acquire the first public key rsa key1 authorized from the first memory 312.

In Step 404, a signature verification is performed on the system boot program.

In this step, the power-up boot program signature verification module 3111 may acquire a signature-carrying system boot program (uboot) 21 from the second memory 313, and may perform a signature verification on the signature-carrying system boot program 21 according to the first public key rsa key1. Reference may be made to the related contents above for a specific verification method, and detailed descriptions thereof are omitted herein.

In Step 405, it is determined whether the system boot program succeeds in the signature verification. Step 406 is performed when the system boot program succeeds in the signature verification; otherwise, Step 426 is performed.

In Step 406, the system boot program is launched to acquire a second public key authorized.

In this step, the processor 311 may launch the system boot program (uboot), and may acquire the second public key rsa key2 from the first memory 312 via a system boot program signature verification module 3112, and acquire a boot parameter carrying a signature from the second memory 313. The boot parameter carrying the signature is similar in file structure to the above signature-carrying system boot program, and thus its detailed descriptions are omitted herein.

In Step 407, a signature verification is performed on the boot parameter.

In this step, the system boot program signature verification module 3112 may perform a signature verification on the boot parameter (bootargs) carrying the signature by using the second public key rsa key2. The method for signature verification of the boot parameter is similar to the method for signature verification of the system boot program above, and thus its detailed descriptions are omitted herein.

In Step 408, it is determined whether the boot parameter succeeds in the signature verification. Step 409 is performed when the boot parameter succeeds in the signature verification; otherwise, Step 426 is performed. That is, only after the boot parameter succeeds in the signature verification can the boot parameter be used. If the boot parameter fails in the signature verification, the system boot program cannot use the boot parameter, the system boot program is terminated, and thus no subsequent program (such as kernel, recovery, etc.) can be launched.

In Step 409, the boot parameter is set.

In Step 410, it is determined whether to execute a kernel image. Step 411 is performed if the determination result is yes, otherwise Step 416 is performed.

In this step, it is determined to execute the kernel image if no operation behavior of a user is detected. Step 411 is performed if it is detected that the user selects the operation of executing the kernel image. Step 416 is performed if it is detected that the user selects the operation of executing the recovery image.

In Step 411, the kernel image is verified.

In this step, the system boot program signature verification module 3112 may acquire a kernel image carrying a signature from the second memory 313, and perform a signature verification on the kernel image carrying the signature by using the second public key rsa key2. The method for signature verification of the kernel image is similar to the method for signature verification of the system boot program above, and thus its detailed descriptions are omitted herein.

In Step 412, it is determined whether the kernel image succeeds in the signature verification. Step 413 is performed if the determination result is yes; otherwise, Step 426 is performed.

In Step 413, a designated image is verified. That is, after the kernel image succeeds in the signature verification, the system boot program signature verification module 3112 verifies other designated images. Specifically, the system boot program signature verification module 3112 acquires a designated image carrying a signature from the second memory 313, and performs a signature verification on the designated image carrying the signature by using the second public key rsa key2. The designated image may be one or more.

In Step 414, it is determined whether the designated image succeeds in the signature verification. Step 415 is performed if the determination result is yes, otherwise Step 426 is performed.

In this step, if there are a plurality of designated images, it is determined that the designated images succeed in the signature verification when all the designated images succeed in the signature verification, and Step 415 is performed. It is determined that the designated images fail in the signature verification when any one of the designated images fails in the signature verification, and in this case, Step 426 is performed.

In Step 415, the kernel image is executed.

In Steps 411˜415 and Step 426, a signature verification is performed on the kernel image carrying the signature and the designated images. The kernel image is executed when both the kernel image carrying the signature and all the designated images succeed in the signature verification. However, the kernel image is prohibited from being executed and the system boot program is terminated when either the kernel image carrying the signature or any one of the designated boot images fails in the signature verification.

In Step 416, the recovery image is verified.

In this step, an upgrade program signature verification module 3113 may acquire a recovery image carrying a signature from the second memory 313, and perform a signature verification on the recovery image carrying the signature by using the second public key rsa key2.

In Step 417, it is determined whether the recovery image succeeds in the signature verification. Step 418 is performed if the determination result is yes; otherwise, Step 426 is performed.

In Step 418, the recovery image is executed.

In Step 419, an upgrade package is unzipped. In this step, at least one image may be obtained by unzipping the upgrade package.

In Step 420, it is determined whether the image carries a signature. Step 421 is performed if the determination result is yes; otherwise, Step 424 is performed.

In this step, the upgrade program signature verification module 3113 may acquire an image from the second memory 313, and may determine whether the image carries a signature. Step 423 is performed if the image does not carry the signature; otherwise, Step 421 is performed.

In Step 421, the boot image is verified. In this step, the upgrade program signature verification module 3113 may perform a signature verification on the image carrying the signature by using the second public key rsa key2.

In Step 422, it is determined whether the image succeeds in the verification. Step 424 is performed if the determination result is yes; otherwise, Step 427 is performed.

In Step 423, it is determined whether an unverified image is present in the upgrade package. Step 424 is performed if the determination result is yes; otherwise, Step 425 is performed.

In Step 424, the unverified image is acquired.

In Step 425, upgrading of the recovery image is executed.

In Steps 416˜425 and Step 427, a signature verification is performed on the recovery image carrying the signature when it is determined not to execute the kernel image. The recovery image is executed when the recovery image succeeds in the signature verification. A signature verification is performed on an image carrying a signature in an upgrade package in the process of executing the recovery image. Executing the recovery image is terminated when any image in the upgrade package fails in the signature verification. Upgrading of the recovery image is executed when all the images in the upgrade package succeed in the signature verification. Executing the recovery image is prohibited and the system boot program is terminated when the recovery image fails in the signature verification.

In practical applications, a main flow function install_package is executed after the recovery image is executed. A function really_install_package is called in the main flow function install_package. After the function really_install_package calls verify_file, a function check_signagure is executed to verify each image carrying a signature in a zip package (upgrade package), and the recovery image is terminated if any image carrying a signature fails in the signature verification.

In Step 426, the system boot program is terminated.

In Step 427, executing the recovery image is terminated.

In this embodiment, to ensure that the first program (such as uboot in Android/Linux) of the system of the vehicle-mounted device jumped from hardware is legal, and to ensure that any feasible image (kernel, recovery, etc.) in a launching process is legal, a signature verification is performed on the uboot, and a signature verification is performed on the above feasible image in the process of launching the system. In this regard, it may be ensured that the system is securely launched. It is to be noted that the embodiments of the present disclosure also may be applicable to other operating systems, and are not limited to Android and Linux operating systems.

In this embodiment, after the system of the vehicle-mounted device is powered up, the system boot program is verified, and a signature verification is performed on the feasible image in the process of launching the system. In this regard, it may be ensured that the system is securely launched.

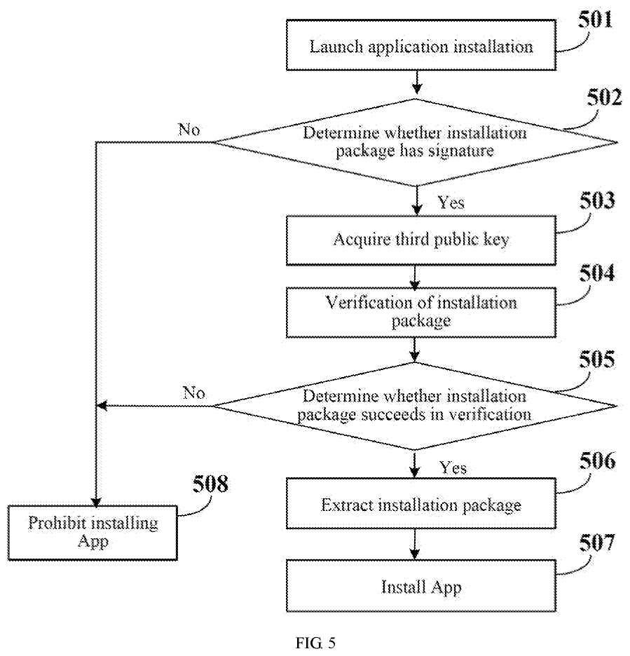

FIG. 5 illustrates still another security verification method for a vehicle-mounted device according to an embodiment of the present disclosure, to ensure App installation security. In this embodiment, a signature verification is performed on the application program carrying the signature according to the third public key acquired. The application program is installed when the signature verification succeeds; otherwise installing the application program is prohibited. Specifically, as shown in FIG. 5, the security verification method for a vehicle-mounted device may include the following Steps 501˜508.

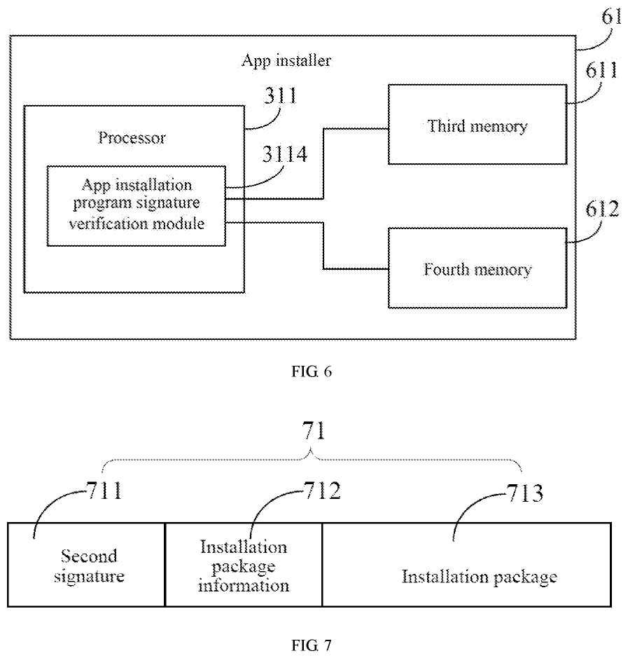

In Step 501, an application installation is launched. In this step, if the vehicle-mounted device detects an installation instruction of an application program (which may be abbreviated as “App”), an App installation program may be launched by the App installer 61 as shown in FIG. 6. Specifically, an App installation program signature verification module 3114 may acquire an installation package of the application program from a fourth memory 612.

As shown in FIG. 7, before the installation package of the application program is written to the fourth memory 612, the RSASSA-PKCS1-v1_5/SHA1 algorithm is used as a signature algorithm of the installation package, and the installation package is calculated to obtain a second signature 711. The second signature 711, installation package information 712 (for example, length information of the installation package) and the installation package 713 are combined into one file, i.e., a signature-carrying installation package 71.

In Step 502, it is determined whether the installation package has a signature. Step 503 is performed if the determination result is yes; otherwise, Step 508 is performed.

In Step 503, the third public key is acquired. That is, after determining that the installation package has the signature, the App installation program signature verification module 3114 may acquire the third public key rsa key3 from a third memory 611 to perform a signature verification. The third memory 611 may be a security memory.

In Step 504, the installation package is verified. In this step, the App installation program signature verification module 3114 may perform a signature verification on the signature-carrying installation package 71 by using the third public key rsa key3. Specifically, the App installation program signature verification module 3114 may decrypt the second signature 711 by using the third public key rsa key3 to obtain a decrypted digest, then may calculate the digest of the installation package 713 by using the sha1 algorithm, and thereafter compare the decrypted digest with the calculated digest. The signature verification succeeds if the decrypted digest is consistent with the calculated digest; otherwise, the signature verification fails.

In Step 505, it is determined whether the installation package succeeds in the signature verification. Step 506 is performed if the determination result is yes; otherwise, Step 508 is performed.

In Step 506, the installation package is extracted. That is, after the installation package succeeds in the signature verification, the installation package 713 is extracted from the signature-carrying installation package 71.

In Step 507, the App is installed.

In Step 508, installing the App is prohibited.

In one embodiment, a signature verification needs to be performed on all application programs before installation, and only those successfully verified application programs can be installed. In this regard, it is ensured that all the application programs in the software system of the vehicle-mounted device are legitimate Apps, and unauthorized Apps cannot run.

In this embodiment, the security of installation of the application programs may be improved by performing a signature verification on the application programs before the application programs are installed.

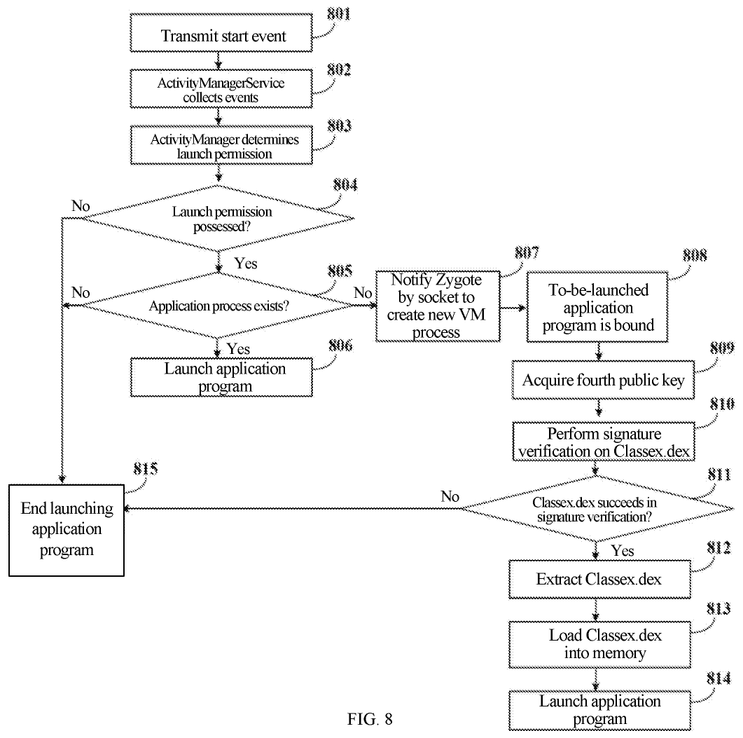

FIG. 8 illustrates still another security verification method for a vehicle-mounted device according to an embodiment of the present disclosure, to ensure App running security. In this embodiment, a signature verification may be performed on an executable file carrying a signature according to the fourth public key acquired in the node location where a target application program is loaded for the first time. The executable file is extracted and is loaded into a memory when the signature verification succeeds. However, launching the target application program is prohibited when the signature verification fails. Specifically, as shown in FIG. 8, the security verification method for a vehicle-mounted device may include the following Steps 801˜816.

In Step 801, a start event is transmitted. In this step, the start event (intent) is transmitted to ActivityManagerService if an instruction of launching an application program is detected.

In Step 802, the ActivityManagerService collects events. In this step, the ActivityManagerService may collect the start events.

In Step 803, the ActivityManagerService determines a launch permission. In this step, the ActivityManagerService may determine a launch permission of launching an application program. For example, the ActivityManagerService may determine whether a user A has a launch permission of launching an application program A. For example, the ActivityManagerService may determine whether the user A has the launch permission when launching the application program A by way of identity authentication and password authentication, but is not limited thereto.

In Step 804, it is determined whether the launch permission is possessed. Step 805 is performed if the determination result is yes; otherwise, Step 814 is performed.

In Step 805, it is determined whether an application process exists. Step 806 is performed if the determination result is yes; otherwise, Step 807 is performed. In this step, if it is determined that the application process exists, this indicates that an application program corresponding to the application process is not launched for the first time, and this application program is a legitimate application program and may be directly launched.

In Step 806, the application program is launched.

In Step 807, Zygote is notified by socket to create a new virtual machine process.

In Step 808, a to-be-launched application program is bound. In this step, the created virtual machine process is bound with the to-be-launched application program.

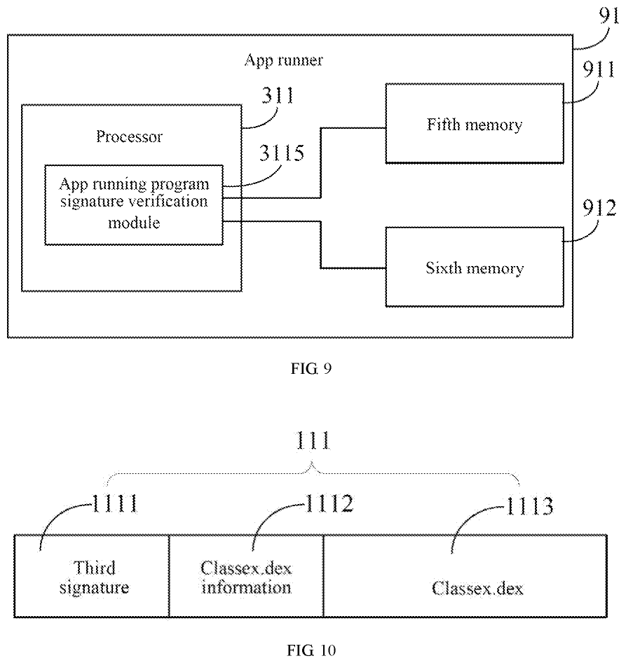

In Step 809, the fourth public key is acquired. In this step, an App running program signature verification module 3115 in an App runner 91 as shown in FIG. 9 may acquire the fourth public key rsa key4 from a fifth memory 911. The fifth memory 911 may be a security memory.

In Step 810, a signature verification is performed on Classex.dex.

In this step, the App running program signature verification module 3115 may perform a signature verification on the Classex.dex carrying a signature by using the fourth public key rsa key4. Specifically, as shown in FIG. 10, the Classex.dex 111 carrying the signature includes a third signature 1111, Classex.dex information 1112, and Classex.dex 1113. The Classex.dex information includes length information of the Classex.dex. Specifically, the App running program signature verification module 3115 may decrypt the third signature 1111 by using the fourth public key rsa key4 to obtain a decrypted digest, then may calculate the digest of the Classex.dex by using the sha1 algorithm, and then may compare the decrypted digest with the calculated digest. The signature verification succeeds if the decrypted digest is consistent with the calculated digest; otherwise, the signature verification fails.

In Step 811, it is determined whether the Classex.dex succeeds in the signature verification. Step 812 is performed if the determination result is yes; otherwise, Step 815 is performed.

In Step 812, the Classex.dex is extracted. That is, after the Classex.dex succeeds in the signature verification, the Classex.dex1113 is extracted from the Classex.dex111 carrying the signature.

In Step 813, the Classex.dex is loaded into a memory.

In Step 814, an application program is launched.

In Step 815, launching of the application installation is ended.

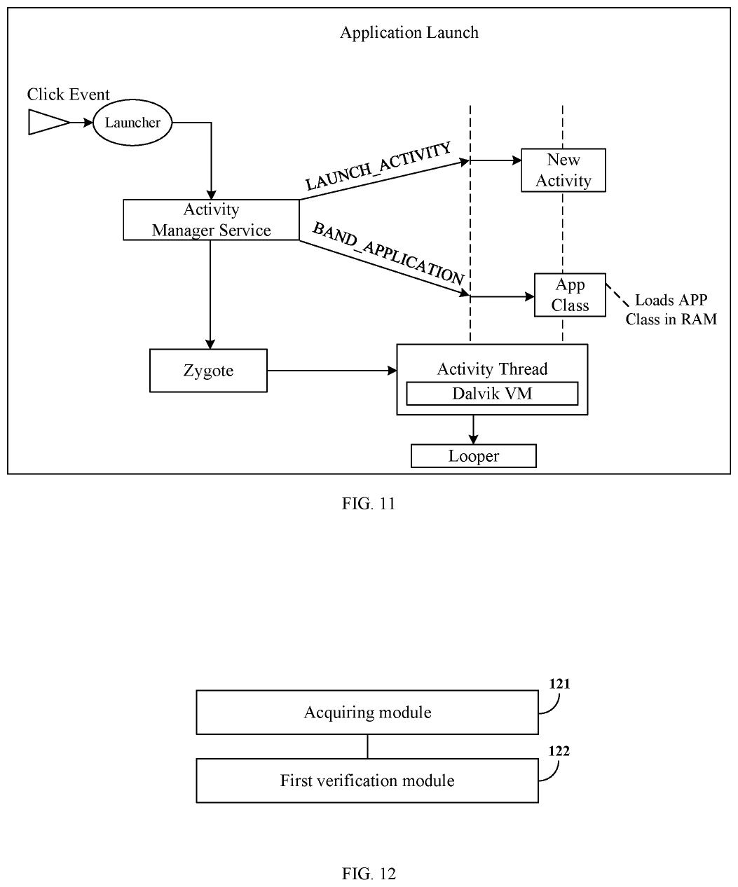

In one exemplary embodiment, as shown in FIG. 11, the system of the vehicle-mounted device is an Android operating system. The Classex.dex needs to be loaded into the memory (Loads APP class in RAM) when the Android operating system loads the application program for the first time. Therefore, before the Classex.dex is loaded, a signature verification needs to be performed on the Classex.dex, and only the successfully verified classes.dex can be loaded into the memory to be run. In this regard, the running security of the APP may be ensured. In FIG. 11, Click Event represents a click event, Launcher represents a launcher, ActivityManagerService represents an activity manager service, BAND_APPLICATION means that the new created virtual machine process is bound with the to-be-launched application program, LAUNCH_ACTIVITY means that the application program is launched, App Class represents an App class, New Activity represents a new activity, Activity Thread represents an activity thread, Dalvik VM represents a virtual machine, and Looper represents a message looper.

In this embodiment, a signature verification is performed on an executable file carrying a signature of a target application program in the node location where the target application program is loaded for the first time. The executable file is extracted and is loaded into the memory when the signature verification succeeds. However, launching the target application program is prohibited when the signature verification fails. In this regard, the running security of the application program may be ensured.

FIG. 12 illustrates a block diagram of a vehicle-mounted device according to an embodiment of the present disclosure. As shown in FIG. 12, the vehicle-mounted device includes:

an acquiring module 121, configured to acquire a target object to be verified in at least one security verification location, the security verification location being a node location to be security-verified after the vehicle-mounted device is powered up; and

a first verification module 122, configured to perform a security verification on the target object, wherein the target object is allowed for use when the security verification succeeds, and the target object is prohibited from being used when the security verification fails.

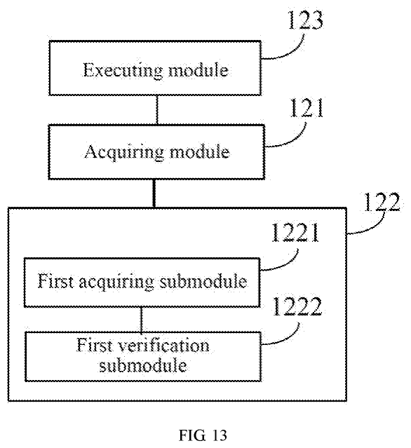

FIG. 13 illustrates a block diagram of another vehicle-mounted device according to an embodiment of the present disclosure. In this embodiment, the security verification location is a node location where a system boot program is executed. The target object is the system boot program carrying a signature. The vehicle-mounted device may further include: an executing module 123, configured to execute a power-up boot program after the vehicle-mounted device is powered up.

The first verification module 122 includes:

a first acquiring submodule 1221, configured to acquire a first public key authorized in the process of executing the power-up boot program; and

a first verification submodule 1222, configured to perform a signature verification on the system boot program carrying the signature according to the first public key.

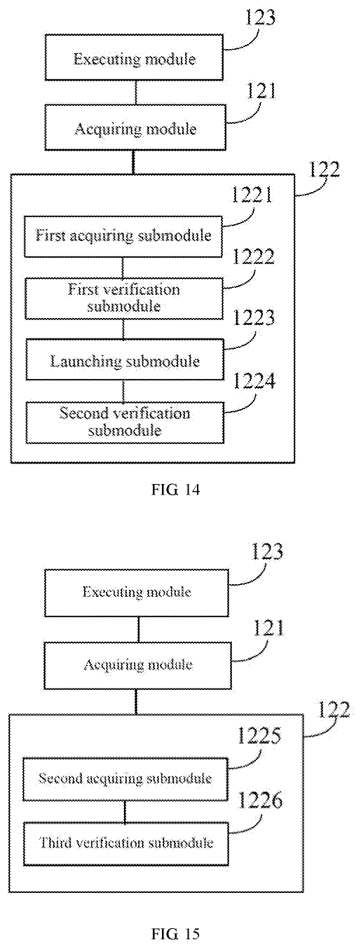

FIG. 14 illustrates a block diagram of still another vehicle-mounted device according to an embodiment of the present disclosure. In this embodiment, the first verification module 122 may further include:

a launching submodule 1223, configured to launch the system boot program to acquire a second public key authorized when the system boot program carrying the signature succeeds in the signature verification; and

a second verification submodule 1224, configured to perform a signature verification on a boot parameter carrying a signature according to the second public key, wherein the system boot program is terminated when the boot parameter carrying the signature fails in the signature verification, and the system boot program sets the boot parameter when the boot parameter carrying the signature succeeds in the signature verification.

FIG. 15 illustrates a block diagram of still another vehicle-mounted device according to an embodiment of the present disclosure. In this embodiment, the security verification location is a node location where an application program is installed, and the target object is an application program carrying a signature.

The first verification module 122 may include:

a second acquiring submodule 1225, configured to acquire a third public key authorized; and

a third verification submodule 1226, configured to perform a signature verification on the application program carrying the signature according to the third public key; wherein the application program is installed when the signature verification succeeds, but installing the application program is prohibited when the signature verification fails.

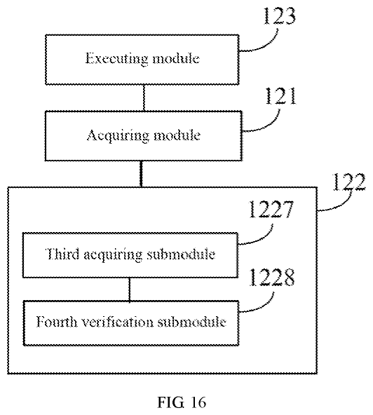

FIG. 16 illustrates a block diagram of still another vehicle-mounted device according to an embodiment of the present disclosure. In this embodiment, the security verification location is a node location where a target application program is loaded for a first time. The target object is an executable file carrying a signature of the target application program. The first verification module 122 may include:

a third acquiring submodule 1227, configured to acquire a fourth public key authorized; and

a fourth verification submodule 1228, configured to perform a signature verification on the executable file carrying the signature according to the fourth public key; wherein the executable file is extracted and is loaded into a memory when the signature verification succeeds; but launching the target application program is prohibited when the signature verification fails.

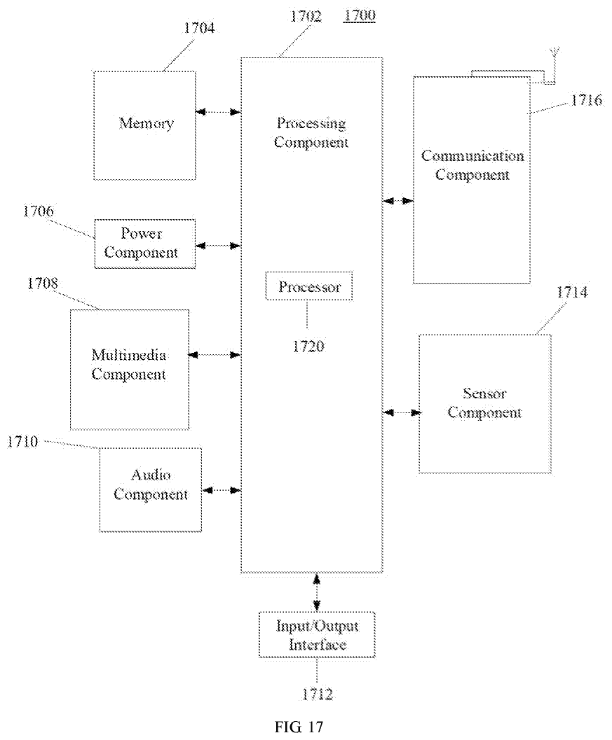

FIG. 17 illustrates a block diagram of an electronic device according to an exemplary embodiment. For example, the device 1000 may be a vehicle-mounted device, a mobile phone, a computer, a digital broadcast terminal, a message transceiver device, a games console, a tablet device, medical equipment, fitness equipment, a personal digital assistant, and the like.

Referring to FIG. 17, the device 1700 may include one or more of the following components: a processing component 1702, a memory 1704, a power component 1706, a multimedia component 1708, an audio component 1710, an input/output (I/O) interface 1712, a sensor component 1714, and a communication component 1716.

The processing component 1702 typically controls overall operations of the device 1700, such as the operations associated with display, telephone calls, data communications, camera operations, and recording operations. The processing component 1702 may include one or more processors 1720 to execute instructions to perform all or part of the steps in the above described methods. Moreover, the processing component 1702 may include one or more modules which facilitate the interaction between the processing component 1702 and other components. For instance, the processing component 1702 may include a multimedia module to facilitate the interaction between the multimedia component 1708 and the processing component 1702.

The memory 1704 is configured to store various types of data to support the operation of the device 1700. Examples of such data include instructions for any application programs or methods operated on the device 1700, contact data, phonebook data, messages, pictures, videos, etc. The memory 1704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1706 provides power to various components of the device 1700. The power component 1706 may include a power management system, one or more power sources, and any other components associated with the generation, management, and distribution of power in the device 1700.

The multimedia component 1708 includes a screen providing an output interface between the device 1700 and the user. In some embodiments, the screen may include a liquid crystal display (LCD) and a touch panel (TP). If the screen includes the touch panel, the screen may be implemented as a touch screen to receive input signals from a user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 1708 includes a front camera and/or a rear camera. The front camera and/or the rear camera may receive an external multimedia datum while the device 1700 is in an operation mode, such as a photographing mode or a video mode. Each of the front camera and the rear camera may be a fixed optical lens system or have focus and optical zoom capability.

The audio component 1710 is configured to output and/or input audio signals. For example, the audio component 1710 includes a microphone (“MIC”) configured to receive an external audio signal when the device 1700 is in an operation mode, such as a call mode, a recording mode, and a voice recognition mode. The received audio signal may be further stored in the memory 1704 or transmitted via the communication component 1716. In some embodiments, the audio component 1710 further includes a speaker to output audio signals.

The I/O interface 1712 provides an interface between the processing component 1702 and peripheral interface modules, such as a keyboard, a click wheel, buttons, and the like. The buttons may include, but are not limited to, a home button, a volume button, a starting button, and a locking button.

The sensor component 1714 includes one or more sensors to provide status assessments of various aspects of the device 1700. For instance, the sensor component 1714 may detect an open/closed status of the device 1700, relative positioning of components, e.g., the display and the keypad, of the device 1700, a change in position of the device 1700 or a component of the device 1700, a presence or absence of user contact with the device 1700, an orientation or an acceleration/deceleration of the device 1700, and a change in temperature of the device 1700. The sensor component 1714 may include a proximity sensor configured to detect the presence of nearby objects without any physical contact. The sensor component 1714 may also include a light sensor, such as a CMOS or CCD image sensor, for use in imaging applications. In some embodiments, the sensor component 1714 may also include an accelerometer sensor, a gyroscope sensor, a magnetic sensor, a pressure sensor, or a temperature sensor.

The communication component 1716 is configured to facilitate communication, wired or wirelessly, between the device 1700 and other devices. The device 1700 can access a wireless network based on a communication standard, such as WiFi, 2G, 3G, or a combination thereof. In one exemplary embodiment, the communication component 1716 receives a broadcast signal or broadcast associated information from an external broadcast management system via a broadcast channel. In one exemplary embodiment, the communication component 1716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as the memory 1704 including instructions. The above instructions may be executed by the processor 1720 in the device 1700, for performing the above-described methods. For example, the non-transitory computer-readable storage medium may be a ROM, a RAM, a CD-ROM, a magnetic tape, a floppy disc, an optical data storage device, and the like.

In the present disclosure, terms “first” and “second” are merely for description purposes, and are not construed as indicating or implying relative importance. Unless otherwise explicitly stated, the term “a plurality of” means two or more than two.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including such departures from the present disclosure as come within known or customary practice in the art. It is intended that the specification and embodiments be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A security verification method for a vehicle-mounted device, comprising:
acquiring a target object to be verified in at least one security verification location, wherein the security verification location is a node location to be security-verified after the vehicle-mounted device is powered up; and
performing a security verification on the target object, wherein the target object is allowed for use when the security verification succeeds, and the target object is prohibited from being used when the security verification fails.

2. The security verification method for a vehicle-mounted device according to claim 1, wherein key pairs used in the security verification in different security verification locations are different.

3. The security verification method for a vehicle-mounted device according to claim 1, wherein the security verification location is a node location where a system boot program is executed, and the target object is the system boot program carrying a signature;
wherein before the acquiring a target object to be security-verified in at least one security verification location, the security verification method further comprises: executing a power-up boot program by the vehicle-mounted device after the vehicle-mounted device is powered up; and
wherein the performing a security verification on the target object comprises:
acquiring a first public key authorized in the process of executing the power-up boot program; and
performing a signature verification on the system boot program carrying the signature according to the first public key.

4. The security verification method for a vehicle-mounted device according to claim 3, wherein, after the performing of the signature verification on the system boot program carrying the signature according to the first public key, the security verification method further comprises:
launching the system boot program to acquire a second public key authorized when the system boot program carrying the signature succeeds in the signature verification; and
performing a signature verification on a boot parameter carrying a signature according to the second public key, wherein the system boot program is terminated when the boot parameter carrying the signature fails in the signature verification, and the system boot program sets the boot parameter when the boot parameter carrying the signature succeeds in the signature verification.

5. The security verification method for a vehicle-mounted device according to claim 4, wherein, after the system boot program sets the boot parameter, the security verification method further comprises:
determining whether to execute a kernel image; and
performing a signature verification on the kernel image carrying a signature and a designated image when it is determined to execute the kernel image, wherein the kernel image is executed when both the kernel image carrying the signature and the designated image succeed in the signature verification, and the kernel image is prohibited from being executed and the system boot program is terminated when either of the kernel image carrying the signature and the designated boot image fails in the signature verification.

6. The security verification method for a vehicle-mounted device according to claim 5, wherein, after the determining of whether to execute the kernel image, the security verification method further comprises:
performing a signature verification on a recovery image carrying a signature when it is determined not to execute the kernel image, executing the recovery image when the recovery image succeeds in the signature verification, and performing a signature verification on an image carrying a signature in an upgrade package in the process of executing the recovery image, wherein the executing the recovery image is terminated when any image in the upgrade package fails in the signature verification; and
prohibiting the recovery image from being executed and terminating the system boot program when the recovery image fails in the signature verification.

7. The security verification method for a vehicle-mounted device according to claim 1, wherein the security verification location is a node location where an application program is installed, and the target object is an application program carrying a signature, wherein the performing a security verification on the target object comprises:
acquiring a third public key authorized; and
performing a signature verification on the application program carrying the signature according to the third public key, wherein the application program is installed when the signature verification succeeds, and the application program is prohibited from being installed when the signature verification fails.

8. The security verification method for a vehicle-mounted device according to claim 1, wherein the security verification location is a node location where a target application program is loaded for a first time, and the target object is an executable file carrying a signature of the target application program, wherein the performing a security verification on the target object comprises:
acquiring a fourth public key authorized; and
performing a signature verification on the executable file carrying the signature according to the fourth public key, wherein the executable file is extracted and is loaded into a memory when the signature verification succeeds, and the target application program is prohibited from being launched when the signature verification fails.

9. An electronic device, comprising:
a hardware processor and a memory storing a computer program, wherein when the computer program is executed by the hardware processor, a security verification method for a vehicle-mounted device comprising the following steps is implemented:
acquiring a target object to be verified in at least one security verification location, wherein the security verification location is a node location to be security-verified after the vehicle-mounted device is powered up; and
performing a security verification on the target object, wherein the target object is allowed for use when the security verification succeeds, and the target object is prohibited from being used when the security verification fails.

10. The electronic device according to claim 9, wherein key pairs used in the security verification in different security verification locations are different.

11. The electronic device according to claim 9, wherein the security verification location is a node location where a system boot program is executed, and the target object is the system boot program carrying a signature;
wherein before the acquiring a target object to be security-verified in at least one security verification location, the security verification method further comprises: executing a power-up boot program by the vehicle-mounted device after the vehicle-mounted device is powered up; and
wherein the performing a security verification on the target object comprises:
acquiring a first public key authorized in the process of executing the power-up boot program; and
performing a signature verification on the system boot program carrying the signature according to the first public key.

12. The electronic device according to claim 11, wherein, after the performing of the signature verification on the system boot program carrying the signature according to the first public key, the security verification method further comprises:
launching the system boot program to acquire a second public key authorized when the system boot program carrying the signature succeeds in the signature verification; and
performing a signature verification on a boot parameter carrying a signature according to the second public key, wherein the system boot program is terminated when the boot parameter carrying the signature fails in the signature verification, and the system boot program sets the boot parameter when the boot parameter carrying the signature succeeds in the signature verification.

13. The electronic device according to claim 12, wherein after the system boot program sets the boot parameter, the security verification method further comprises:
determining whether to execute a kernel image; and
performing a signature verification on the kernel image carrying a signature and a designated image when it is determined to execute the kernel image, wherein the kernel image is executed when both the kernel image carrying the signature and the designated image succeed in the signature verification, and the kernel image is prohibited from being executed and the system boot program is terminated when either of the kernel image carrying the signature and the designated boot image fails in the signature verification.

14. The electronic device according to claim 13, wherein, after the determining of whether to execute the kernel image, the security verification method further comprises:
performing a signature verification on a recovery image carrying a signature when it is determined not to execute the kernel image, executing the recovery image when the recovery image succeeds in the signature verification, and performing a signature verification on an image carrying a signature in an upgrade package in the process of executing the recovery image, wherein the executing the recovery image is terminated when any image in the upgrade package fails in the signature verification; and
prohibiting the recovery image from being executed and terminating the system boot program when the recovery image fails in the signature verification.

15. The electronic device according to claim 9, wherein the security verification location is a node location where an application program is installed, and the target object is an application program carrying a signature, wherein the performing a security verification on the target object comprises:
acquiring a third public key authorized; and
performing a signature verification on the application program carrying the signature according to the third public key, wherein the application program is installed when the signature verification succeeds, and the application program is prohibited from being installed when the signature verification fails.

16. The electronic device according to claim 9, wherein the security verification location is a node location where a target application program is loaded for a first time, and the target object is an executable file carrying a signature of the target application program, wherein the performing a security verification on the target object comprises:
acquiring a fourth public key authorized; and
performing a signature verification on the executable file carrying the signature according to the fourth public key, wherein the executable file is extracted and is loaded into a memory when the signature verification succeeds, and the target application program is prohibited from being launched when the signature verification fails.

17. A non-transitory computer-readable storage medium storing a computer program, wherein, when the computer program is executed by a hardware processor, a security verification method for a vehicle-mounted device comprising the following steps is implemented:
acquiring a target object to be verified in at least one security verification location, wherein the security verification location is a node location to be security-verified after the vehicle-mounted device is powered up; and
performing a security verification on the target object, wherein the target object is allowed for use when the security verification succeeds, and the target object is prohibited from being used when the security verification fails.

18. The computer-readable storage medium according to claim 17, wherein key pairs used in the security verification in different security verification locations are different.

19. The computer-readable storage medium according to claim 17, wherein the security verification location is a node location where a system boot program is executed, and the target object is the system boot program carrying a signature;
wherein, before the acquiring a target object to be security-verified in at least one security verification location, the security verification method further comprises: executing a power-up boot program by the vehicle-mounted device after the vehicle-mounted device is powered up;
wherein the performing a security verification on the target object comprises:
acquiring a first public key authorized in the process of executing the power-up boot program; and
performing a signature verification on the system boot program carrying the signature according to the first public key.

20. The non-transitory computer-readable storage medium according to claim 19, wherein, after the performing of the signature verification on the system boot program carrying the signature according to the first public key, the security verification method further comprises:
launching the system boot program to acquire a second public key authorized when the system boot program carrying the signature succeeds in the signature verification; and
performing a signature verification on a boot parameter carrying a signature according to the second public key, wherein the system boot program is terminated when the boot parameter carrying the signature fails in the signature verification, and the system boot program sets the boot parameter when the boot parameter carrying the signature succeeds in the signature verification.
